(19) United States
(12) Patent Application Publication
(10) Pub. No.: US 2018/0362907 A1
(43) Pub. Date: Dec. 20, 2018

(54) CONTAINER SYSTEM FOR BREWING BEER

(71) Applicant: CM Brewing Technologies, Tustin, CA (US)

(72) Inventor: Curtis C. Kucera, Temecula, CA (US)

(21) Appl. No.: 15/982,982

(22) Filed: May 17, 2018

Related U.S. Application Data
(63) Continuation of application No. 14/804,267, filed on Jul. 20, 2015, now abandoned.
(60) Provisional application No. 62/026,521, filed on Jul. 18, 2014.

(51) Int. Cl. C12C 13/10; C12C 11/00

(52) U.S. Cl. CPC C12C 13/10; C12C 11/00

(57) ABSTRACT

A brewing system may include a first container defining an interior space for brewing a liquid. The first container may include a plurality of legs extending from a lower portion of the first container, and a lid removably connectable to an upper opening of the first container. The first container may be stackable on an identical second container such that the plurality of legs of the first container are seated in one or more slots on opposing sides of a lid of the identical second container.

### CROSS-REFERENCE TO RELATED APPLICATIONS

The present application is a continuation of U.S. patent application Ser. No. 14/804,267, filed Jul. 20, 2015 and entitled “Container System for Brewing Beer”, which application claims priority to U.S. Provisional Patent Application Ser. No. 62/026,521, filed on Jul. 18, 2014, which are hereby incorporated herein, in their entirety, for all purposes.

### SUMMARY

Embodiments disclosed herein may provide for improved brewing convenience, and/or may improve a quality of the produced brew.

In one embodiment, a brewing system may include a first container. The first container may define an interior space for brewing a liquid. The first container may include a plurality of legs extending from a lower portion of the first container, and a lid removably connectable to an upper opening of the first container. The first container may be stackable on an identical second container such that the plurality of legs of the first container are seated in one or more slots on opposing sides of a lid of the second container.

In another embodiment, a fermenter may include a container and a valve assembly. The container may define an interior space for brewing a liquid. The valve assembly may be configured to be operatively coupled to a lower portion of the container for selective evacuation of the liquid from the interior space. The valve assembly may include a valve and a racking arm. The valve may include an aperture through which the liquid is selectively evacuated. The racking arm may be configured to be removably received in the aperture.

In another embodiment, a racking arm assembly for a fermenter may include a valve and a racking arm. The valve may include an aperture, and may be configured to permit selective evacuation of liquid from an interior of the fermenter to a location outside of the fermenter through the aperture. The racking arm may be configured to be removably received in the aperture such that an outer surface of the racking arm exerts an outward pressure on an inner surface of the aperture when received therein.

### BRIEF DESCRIPTION OF THE DRAWINGS

FIG. 1 is a digital photograph of a fermenter (or container) including an upper frustoconical sidewall, a lower conical sidewall, a lid, a plurality of legs, and a valve assembly.

FIG. 2 is a side view of the fermenter with the lid removed.

FIG. 3 is a top view of the fermenter with the lid removed to show an interior space defined by the fermenter.

FIG. 4 is a top view of the lid showing a continuous slot extending around an entire perimeter region of the lid, and a grommet disposed in the slot.

FIG. 5 is a side view of the lid with the right-hand side of the lid shown in cross-section.

FIG. 6 is a partially exploded perspective view of a valve and racking arm of the valve assembly oriented with a hole in the lower conical sidewall.

FIG. 7 is a cross-section of the valve.

FIG. 8 is a cross-section of the racking arm.

FIG. 9 is a magnified cross-section of the racking arm showing dented (not cut) recesses in which O-rings may be disposed.

FIGS. 10A-C and 11A-C are respectively corresponding digital photographs showing rotation of the valve assembly, with rotation of the valve outside of the interior space of the fermenter causing rotation of the racking arm inside the interior space.

FIG. 12 is a side view of a brewing system, including first and second identical fermenters, in a stacked configuration, with right-hand sides of respective lids shown in cross-section.

FIG. 13 is a detailed view of a portion of FIG. 12 showing one of the legs of the first fermenter seated in a slot included in the lid of the second fermenter.

FIG. 14 is a digital photograph of the system in the stacked configuration showing disposal of a bubbler in a hole formed in the lid of the second fermenter.

FIG. 15 is a side view of the system in a nested configuration.

FIG. 16 shows various exemplary dimensions and component materials which may be incorporated into the system.

FIG. 17 is a cross-section similar to FIG. 7, but showing exemplary dimensions of various components, and an alternative shape for a right-hand portion of an aperture for receiving the racking arm.

FIG. 18 is a cross-section of an alternative embodiment of a racking arm, which may be suitable for the being received in the alternatively shaped right-hand portion of the aperture.

FIG. 19 is a cross-section similar to FIG. 8, but showing exemplary dimensions of various components and an exemplary bend angle.

### DETAILED DESCRIPTION

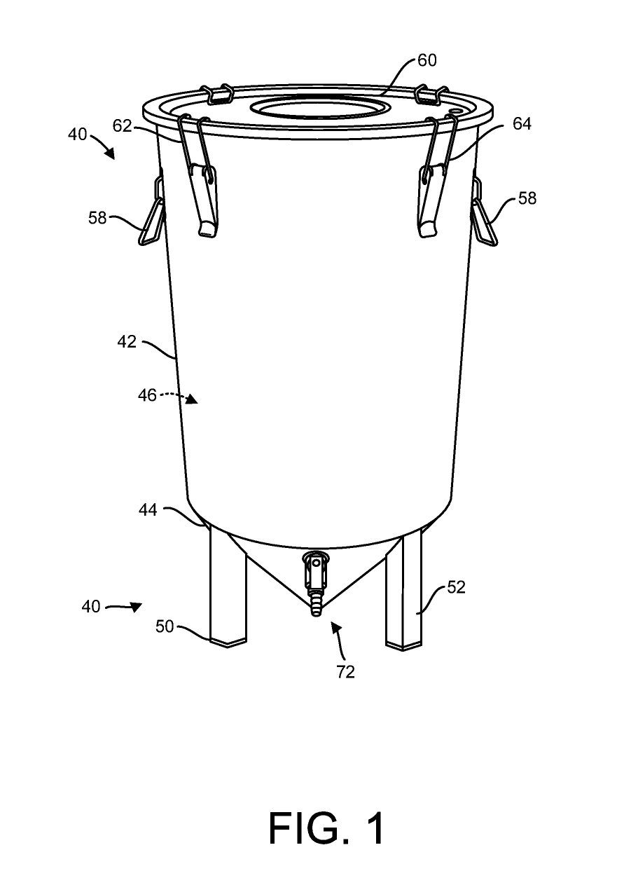

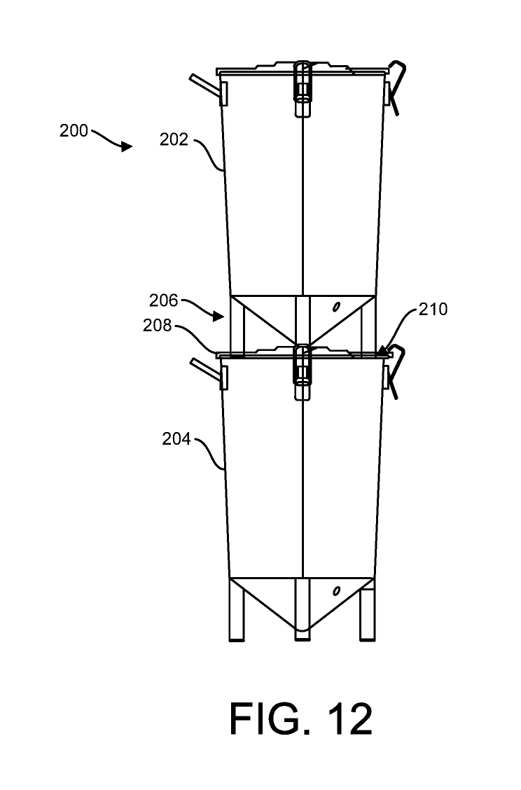

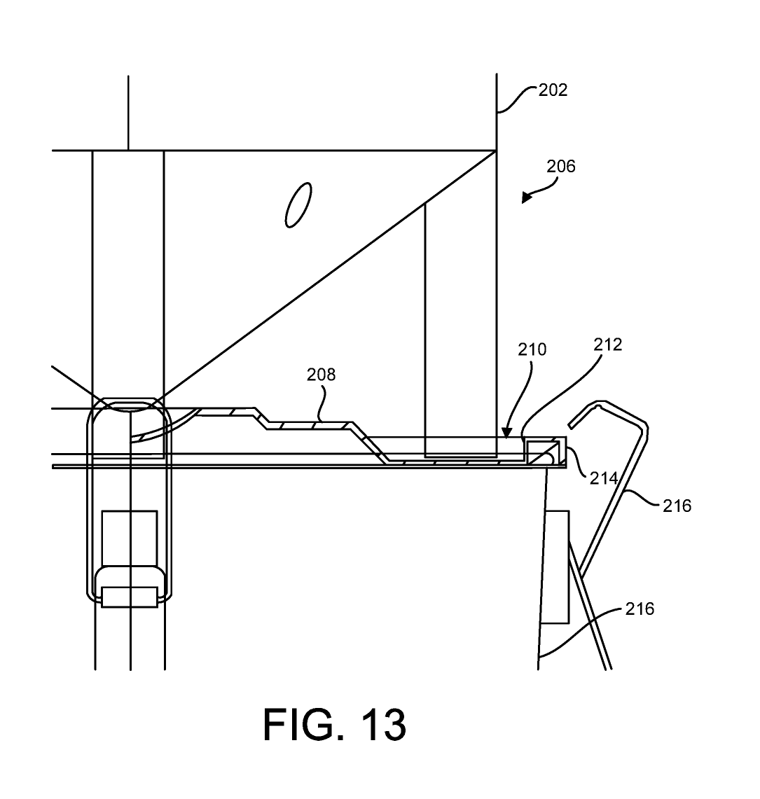

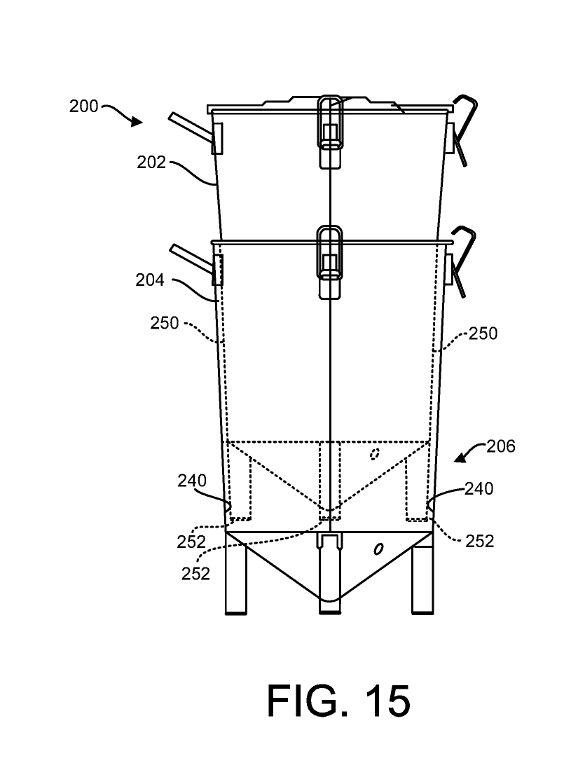

FIGS. 1-11C depict exemplary components of a fermenter 40, one or more of which may be included in a system that may be operable between a stacked configuration (e.g., as shown in FIGS. 12-14) and a nested configuration (e.g., as shown in FIG. 15).

Referring to FIGS. 1-5, fermenter 40 may include an upper sidewall 42 connected to a lower sidewall 44 to define an interior space 46 for brewing or fermenting a liquid (e.g., beer, wine, sake, makgeolli, among others). As shown, sidewall 42 may be generally frustoconical in shape, and sidewall 44 may be generally conical in shape. The frustoconical shape of sidewall 42 may provide for convenient nesting of two or more fermenters (e.g., see FIG. 15). The conical shape of sidewall 44 may reduce a contact area between the brewing (or brewed) liquid and sediment, such as trub, which may be created during the brewing process (e.g., when brewing beer). Pre-existing fermenters, particularly fermenters designed for “home-brewing” (e.g., carboys), typically have flat bottoms, which allow trub to cover a large surface area that is in contact with the brewing liquid leading to “off” (or undesirable) flavors as the liquid ferments. Some pre-existing fermenters include conical shaped bottoms, but these are generally intended to remove trub or harvest yeast during fermentation (not reduce contact between contained trub and the liquid).

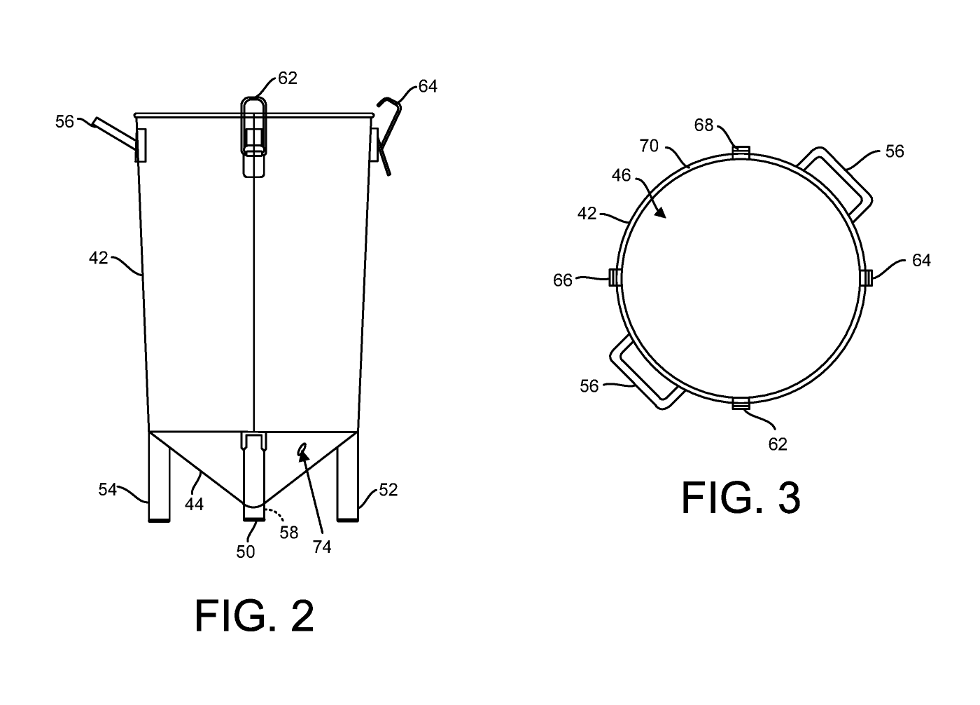

Fermenter 40 may include a plurality of legs 48 (e.g., first, second, third, and fourth legs 50, 52, 54, 58) extending from a lower portion of fermenter 40. For example, legs 48 may be connected to and extend from a perimeter region of conical sidewall 44 adjacent a region where conical sidewall 44 is connected to frustoconical sidewall 42. Legs 48 may be configured to support fermenter 40 in a substantially upright position, as shown. Legs 48 may be equally spaced from one another. For example, leg 48 may be directly behind leg 50 in FIG. 2 but connected to an opposite portion of sidewall 44.

Fermenter 40 may include one or more handles 58, such as two connected to opposite sides of sidewall 42, as shown. Handles 58 may be “fold-out” handles hingedly connected to sidewall 42. Handles 58 may be configured to allow a user to easily move fermenter 40 (e.g., when fermenter 40 is “full” of liquid and/or empty).

Fermenter 40 may include a lid 60, and one or more clamping mechanisms (e.g., first, second, third, and fourth clamping mechanism 62, 64, 66, 68). Lid 60 may be removably connectable to an upper opening or lip 70 of fermenter 40 (e.g., the lip may define the opening), and the one or more clamping mechanisms may be configured to selectively secure lid 40 to an upper portion of fermenter 40 (e.g., to seal opening 70) by gripping one or more clamping surfaces of lid 60, which will be described below in more detail. In other embodiments, one or more of the clamping mechanisms may be configured to secure the lid by gripping one or more clamping surfaces on the upper portion of the fermenter.

Fermenter 40 may include a valve assembly 72. Valve assembly 72 may be configured to be operatively coupled to the lower portion of fermenter 40 (e.g., to a hole 74 formed through an upper portion of sidewall 44) for selective evacuation of the liquid from interior space 46. Additional aspects of assembly 72 will be described below in more detail.

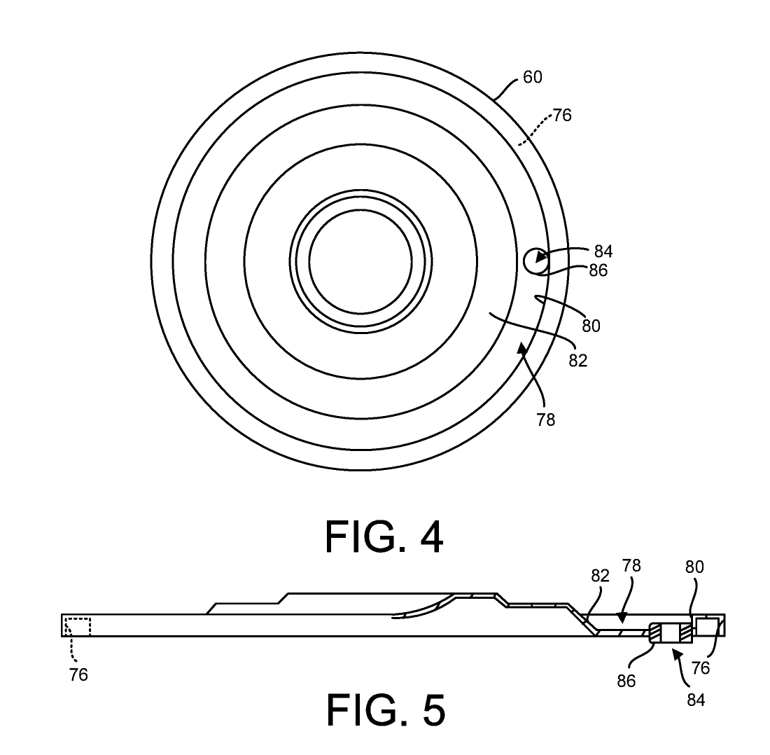

Referring to FIGS. 4 and 5, lid 60 may include a recess 76 extending around a lower side of lid 60. Recess 76 may be configured to receive, contact, and/or press against lip 70 (see FIG. 3) to adequately seal interior space 46.

Further, lid 60 may include one or more slots on opposing sides (e.g., opposing upper sides) of the lid. The one or more slots may be generally vertically aligned with foot portions of legs 48 (see FIGS. 1-5) such that when lip 70 is disposed in recess 76 the foot portions may be directly vertically below and alignable with the one or more slots. This may provide for a first fermenter 40 to be stackable on an identical second fermenter such that legs 48 are seated in one or more identical slots on opposing sides of an identical lid of the second fermenter. For example, the one or more slots may be (or form, or include) a continuous slot 78. Slot 78 may extend around an entire perimeter region of lid 60 (e.g., inside an inner perimeter of recess 76), and may include first and second opposing sidewalls 80, 82.

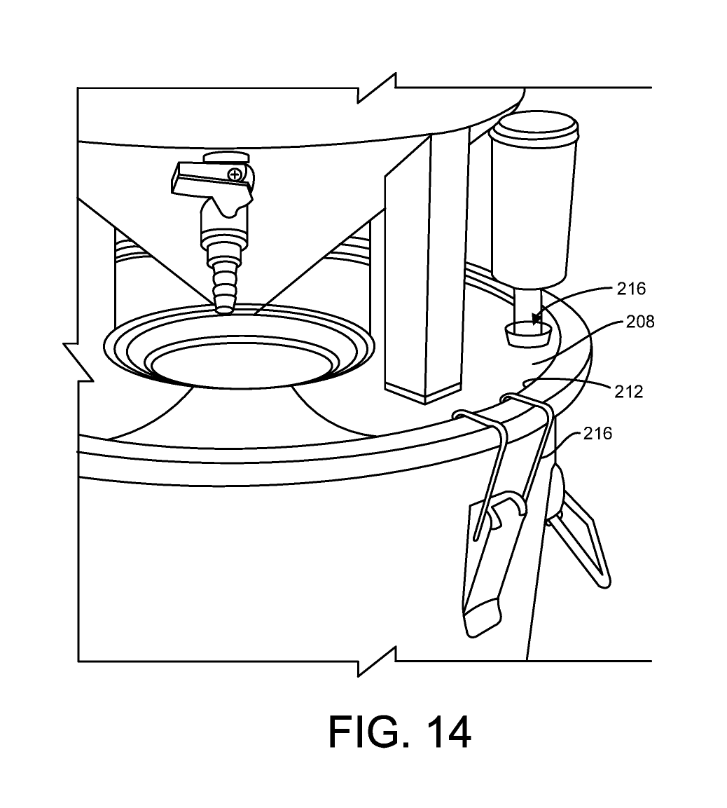

Moreover, lid 60 may include a hole 84 for receiving a bubbler (e.g., see FIG. 14). A grommet 86 may be disposed in hole 84 to provide an adequate seal between a perimeter of hole 84 and the bubbler. As shown, hole 84 may be disposed in slot 78, which may provide for an increased disposal space for the bubbler when the fermenter is in the stacked configuration.

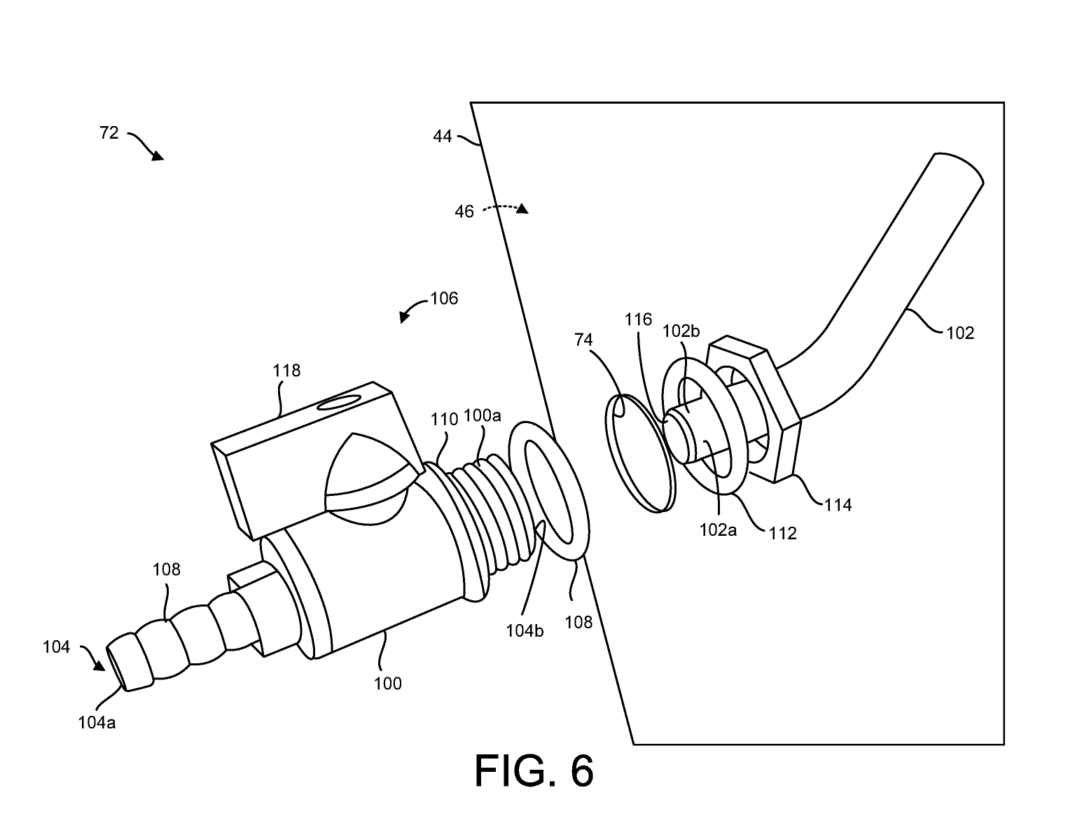

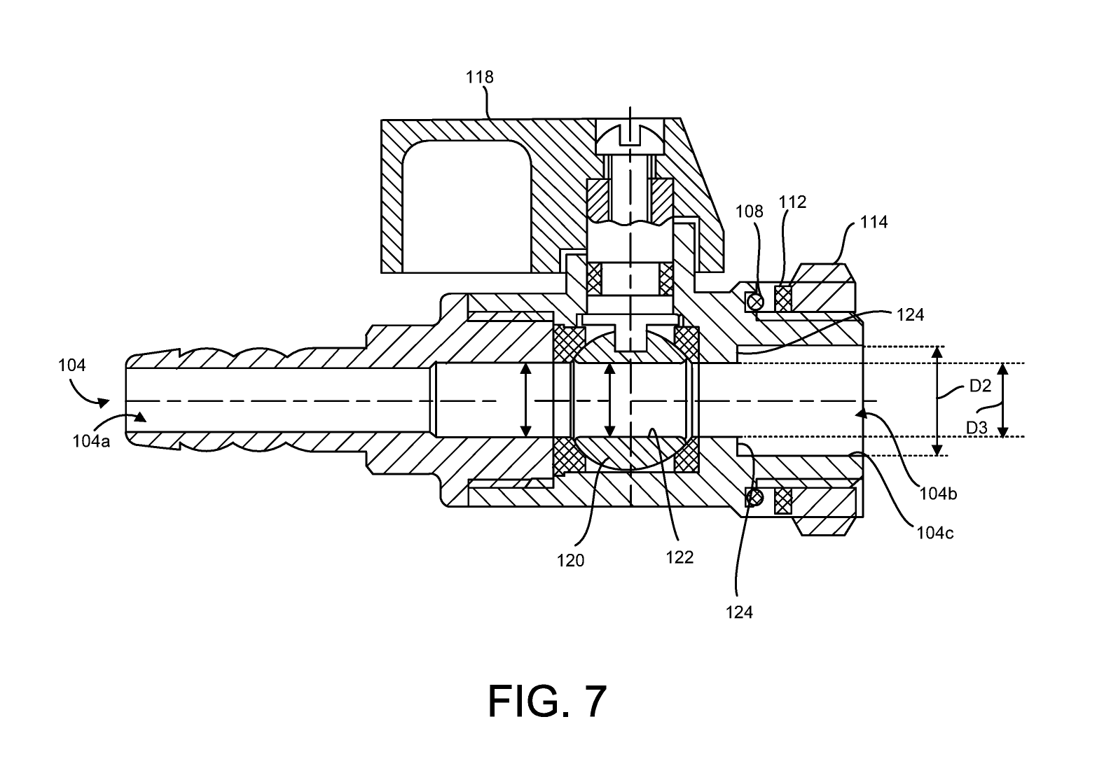

Referring to FIGS. 6-11C, valve assembly 72 may include a valve 100 and a racking arm 102. Valve 100 may include an aperture 104 (having first and second ends 104a, 104b) through which the liquid may be selectively evacuated from interior space 46 to a location 106 outside of interior space 46 (e.g., via a hose connected to a hose bib 108 of valve 100). Racking arm 102 may be bent by an angle 81, and may be configured to be removably received (or receivable) in aperture 104, such as in end 104b. For example, an outer surface 102a of racking arm 102 may exert an outward pressure on an inner surface 104c (see FIG. 7) of aperture 140 when received therein. This type of arrangement or configuration (e.g., the racking arm being removably receivable in aperture 104) may provide a low cost, easy to clean, and/or easy to install racking arm, particularly for a home brewer.

To install assembly 72, the user may insert a threaded end 100a of valve 100 into aperture 74 such that a portion of end 100a is disposed in interior space 46. A first gasket 108 may be disposed between an exterior surface of sidewall 44 and a flange 110 of valve 100. The user may then dispose a second gasket 112 on the portion of thread end 100a disposed inside interior space 46. The user may then thread a nut 114 onto threaded end 100a to clamp sidewall 44 between nut 114 and flange 110 via gaskets 108, 112 to provide an adequate seal. The user may then insert a proximal end 102b of racking arm 102 into end 104b of aperture 104, thereby substantially aligning an aperture 116 of racking arm 102 with aperture 104 and exerting an outward force on inner surface 104c by outer surface 102a. In some embodiments, a portion of sidewall 44 that is clamped by assembly 72 may be substantially flattened, which may improve a seal formed by assembly 72 on sidewall 44.

Valve 100 may include an actuator (or handle) 118 operatively coupled to a valve member 120 for enabling selective obstruction of aperture 104. For example, member 120 may be a ball valve member, as shown in FIG. 7, having a central aperture 122. Turning or otherwise actuating actuator 118 may cause rotation of member 120 (see FIG. 7) to selectively align aperture 122 with aperture 104 (and aperture 116) for evacuation of the liquid, and to selectively block (or obstruct) aperture 104 with a sidewall of member 120 to prevent the liquid from being evacuated out of interior space 46.

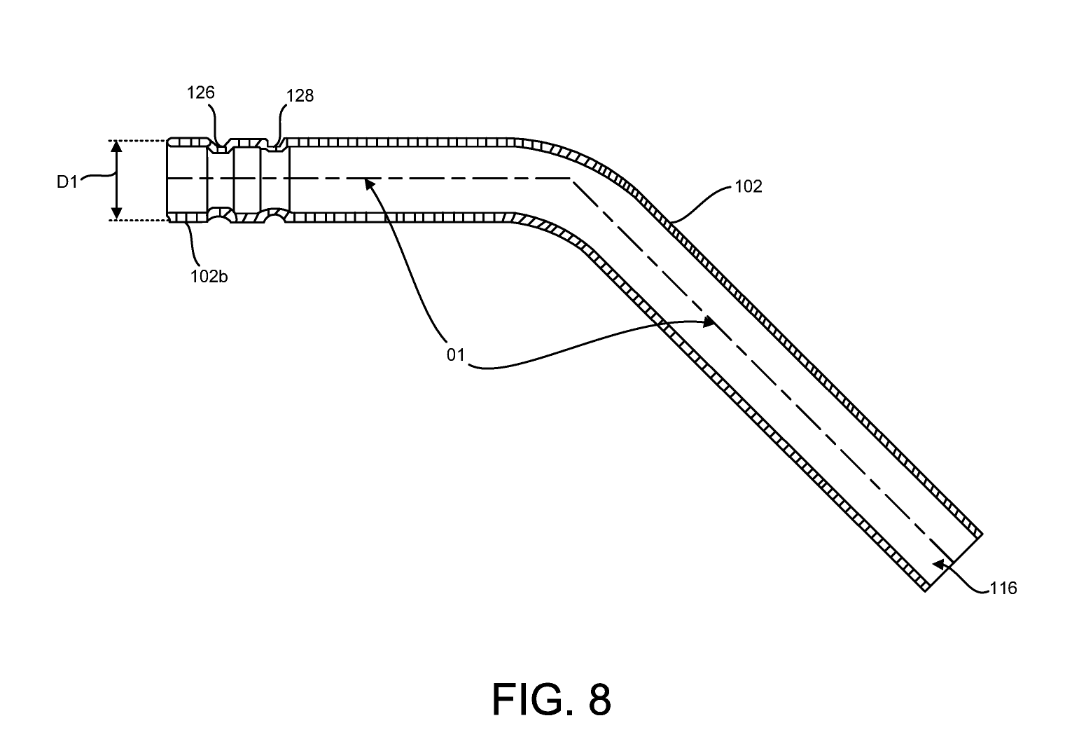

Aperture 104 may be dimensioned to prevent racking arm 102 from contacting member 120 when racking arm 102 is received in aperture 104. For example, a size-differential between racking arm 102 and aperture 104 may be configured to prevent such contact. In particular, end 102a of the racking arm may have an outer diameter D1 (see FIG. 8) that is slightly smaller than an inner diameter D2 (see FIG. 7) of end 104b of aperture 104, but larger than an inner diameter D3 of aperture 104 disposed between member 120 and end 104b. Such a configuration may form a back stop 124 configured to limit how far the racking arm may be inserted into aperture 104, such that the racking arm is prevented from contacting member 120, which if otherwise allowed to occur may result in an undesirable outcome, such as racking arm 102 extending into aperture 122 or damaging the sidewall of member 120. As shown in FIG. 7, back stop 124 is a surface extending substantially perpendicular to an elongate direction of aperture 104, but in other embodiments back stop 124 may have other shapes, such as a tapered shape providing a gradual transition between diameters D2, D3.

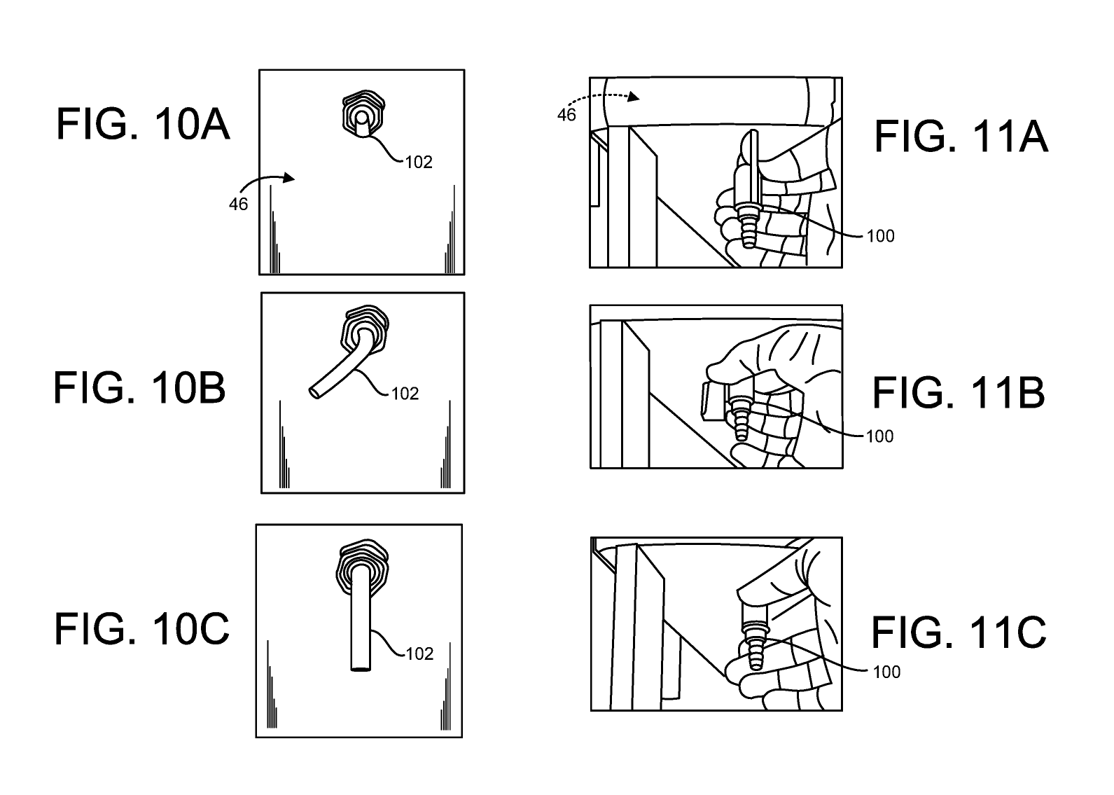

Referring to FIG. 8, proximal end 102b of racking arm 102 may include one or more O-rings (not shown) disposed in one or more recesses (e.g., first and second recesses 126, 128), such that an outer surface of one or more of the O-rings is included in the outer surface of the racking arm which exerts the outward pressure on inner surface 104c of aperture 104 (see FIG. 7). The one or more O-rings may provide for a relatively snug fit of proximal end 102b in aperture 104 (e.g., may be configured to seal against the inner surface of aperture 80), and may prevent racking arm 102 from being inadvertently disengaged from aperture 104 during operation (e.g., rotation) of assembly 72 (e.g., as shown in FIGS. 10A-11C). The one or more O-rings may also provide a suitable frictional engagement between proximal end 102b and aperture 104 to substantially hinder rotation of racking arm 102 relative to aperture 104, which may be particularly undesirable when rotating assembly 72 to evacuate the liquid from fermenter 40 at different depths within interior space 46.

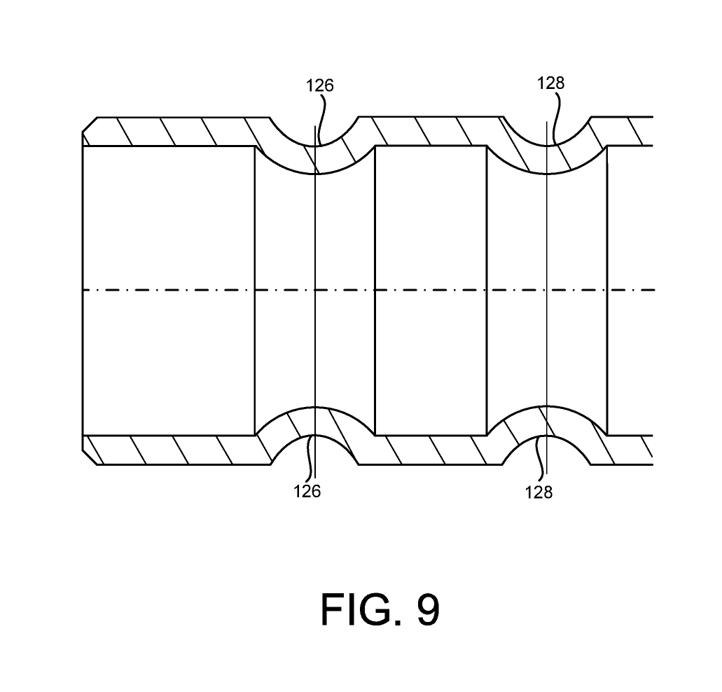

As shown in FIGS. 8 and 9, recesses 126, 128 may be formed by denting in a sidewall (e.g., that defines aperture 116) of racking arm 102. Recesses formed by dents, rather than cuts, may result in smoother racking arm surfaces, which may be more easily cleaned and/or sanitized. For example, forming these recesses with cuts may produce relatively small and/or jagged abrasions or scraps in the sidewall of the racking arm, in which bacteria may thrive and which may be too narrow for conventional cleaning products to penetrate.

As shown in FIGS. 10A-10C and corresponding FIGS. 11A-11C, the racking arm assembly may be rotatable such that rotation of valve 100 outside of interior space 46 (e.g., by a user) causes corresponding rotation of racking arm 102 inside interior space 46 (e.g., by a frictional fit of racking arm 102 inside of the aperture of valve 100). As shown, the corresponding rotation of racking arm 102 is in sync with the rotation of valve 100 even though a frictional engagement between the outer surface of the racking arm and the inner surface of the aperture of the valve may be the only engagement securing these components together. In contrast, pre-existing racking arms are typically coupled to valves by additional fittings that couple an interior surface of the racking arm to an exterior surface of the valve, resulting in a generally more complicated and difficult to clean configuration.

FIGS. 12-14 depict a system 200, including first and second fermenters (or containers) 202, 204. Fermenters 202, 204 may be identical to one another, and/or may both be similar to fermenter 40. For example, fermenters 202, 204 may each include a valve assembly (similar to assembly 72) configured to be operatively coupled to a lower conical portion. As shown, fermenter 202 may be stackable on identical fermenter 204 such that a plurality of legs 206 are seated in one or more slots on opposing sides of a lid 208 of fermenter 204, which may provide for a substantially stable stacked configuration. In particular, the one or more slots of lid 208 may be a continuous slot 210 (e.g., similar to slot 78). Slot 210 may be oversized relative to legs 206 (e.g., relative to each foot portion of each leg) such that at least one clamping surface 212 is provided in slot 210 between at least one leg of the plurality of legs 206 and an outer perimeter 214 of lid 208. A clamping mechanism 216 of fermenter 204 may be configured to selectively sure lid 208 to an upper portion of fermenter 204 by gripping clamping surface 212, as shown in FIG. 14. Other clamping surfaces for the other clamping devices may be similarly provided between the other of legs 206 and corresponding regions of perimeter 214.

Similar to the lid of fermenter 40, lid 208 may include a hole 216 configured for receiving a bubbler 218. The system may be configured to allow disposal of bubbler 218 (or allow the bubbler or another suitable air lock to remain disposed) in hole 216 when fermenter 202 is stacked on fermenter 204, which may be particularly convenient for a home brewer who has limited space in which to brew, such as in a garage. In contrast, pre-existing home brew fermenters (e.g., flat bottom buckets or carboys) are typically not configured to allow a bubbler to be in place on a top portion of the fermenter when another fermenter is stacked thereon, thus preventing these pre-existing fermenters from being stacked on one another when actively brewing liquid therein.

System 200 may be operable between a stacked configuration (e.g., as shown in FIG. 12) and the nested configuration, as shown in FIG. 15. The nested configuration may correspond the lid of fermenter 204 removed and placed on the lid of fermenter 202, and/or to fermenter 202 nested within an interior space of fermenter 204. Legs 206 may be configured to engage an inner surface 240 of fermenter 204 when in the nested configuration. The engagement of legs 206 with surface 240 may be configured to limit contact between an outer surface 250 of fermenter 202 and inner surface 240. In particular, distal ends (or foot portions) 252 of legs 206 may be configured to press outward against surface 240 above the conical lower portion of fermenter 204. Such a configuration may allow for the fermenters to be more easily separated when operating system 200 from the nested configuration to the stacked configuration (e.g., as compared to a configuration in which a majority of surface 250 contacts surface 240 when nested).

Accordingly, as can be appreciated from the above description with reference to the figures, system 200 may allow a brewer with limited space to brew an increased amount of liquid, and to store system 200 in an even more limited space. While FIGS. 12-15 show system 200 as including two fermenters, other embodiments may include any suitable number of fermenters. For example, in some embodiments, a system may include three fermenters, which may all be nested together in a nested configuration, and all may be stacked in a vertical manner on top of one another in a stacked configuration. However, in some embodiments, it may be desirable to stack a fewer number of fermenters on top of one another in the stacked configuration, than are nested within one another in the nested configuration.

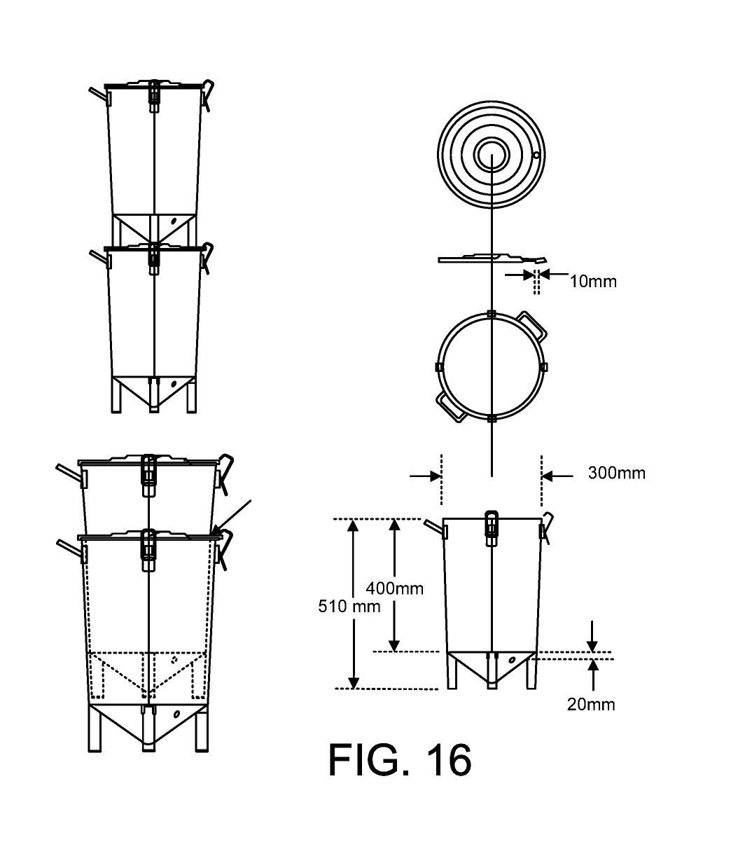

FIGS. 16-19 depict various exemplary dimensions and materials which may be incorporated into (and/or in conjunction with) one or more of the components described herein. For example, as depicted in FIG. 16, legs of a fermenter may be welded to a conical lower portion of the fermenter. Clamping mechanisms for securing a lid may be (or include) spring clips aligned with the legs. The legs, sidewalls, lid, handle, and clamping mechanism may be made of stainless steel.

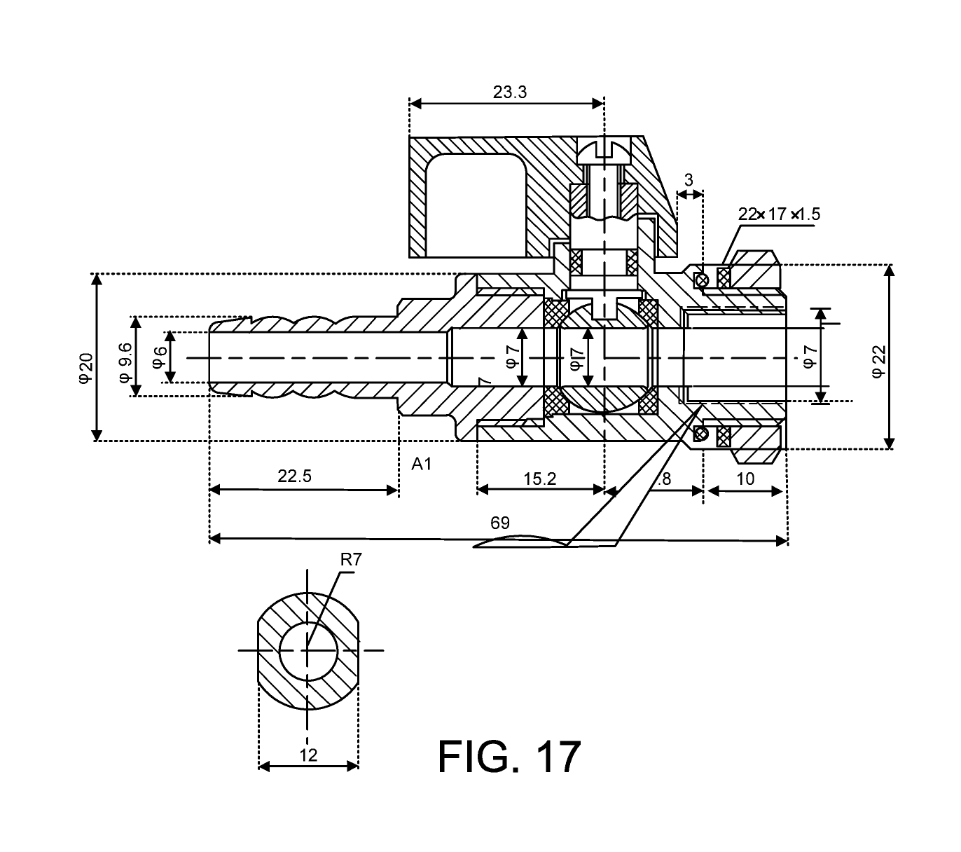

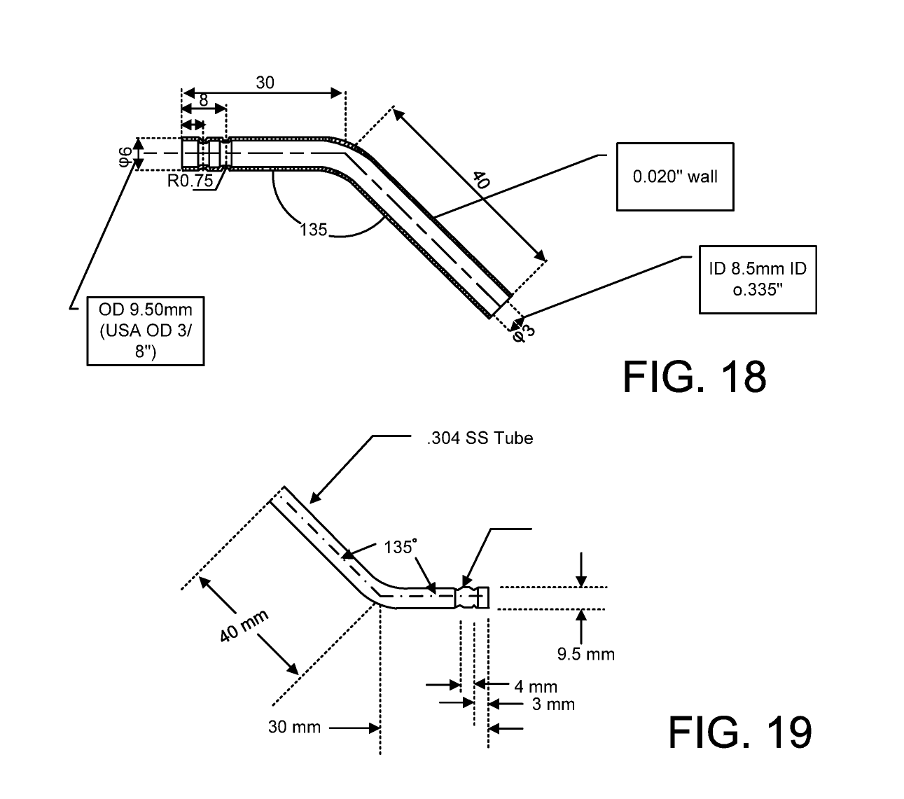

Similarly, various exemplary dimensions are depicted in FIG. 17, along with an alternative embodiment for an end of an aperture of a valve in which a racking arm may be received. In particular, the right-hand side of the aperture extending through the valve may have a diameter that is similar to that of an aperture of a ball valve member. In FIG. 17, dash double dot lines show how this alternative diameter may compare to D2. FIG. 18 depicts an alternative embodiment of a racking arm, which may be suitable for being received in the aperture having the alternative diameter, while FIG. 19 depicts exemplary dimensions for a racking arm that may be received in a 10.0 mm diameter aperture (e.g., indicated by the dash double dot lines in FIG. 17).

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances.

What is claimed:

1. A brewing system comprising:
a first container defining an interior space for brewing a liquid, the first container including a plurality of legs extending from a lower portion of the first container, and a lid removably connectable to an upper opening of the first container;
wherein the first container is stackable on an identical second container such that the plurality of legs of the first container are seated in one or more slots on opposing sides of a lid of the identical second container.

2. The system of claim 1, wherein the lid of the second container includes a hole for receiving a bubbler, the system being configured to allow disposal of the bubbler in the hole when the first container is stacked on the second container.

3. The system of claim 1, wherein the one or more slots is a continuous slot that extends around an entire perimeter region of the lid of the second container.

4. The system of claim 1, wherein the one or more slots are oversized relative to the plurality of legs, such that at least one clamping surface is provided in the one or more slots between at least one leg of the plurality of legs and an outer perimeter of the lid.

5. The system of claim 4, wherein the second container includes a clamping mechanism configured to selectively secure the lid of the second container to an upper portion of the second container by gripping the clamping surface.

6. The system of claim 1, wherein the system is operable between a stacked configuration and a nested configuration, the stacked configuration corresponding to the first container stacked on the second container such that the plurality of legs of the first container are seated in the one or more slots of the lid of the second container, the nested configuration corresponding to the first container nested within an interior space of the second container.

7. The system of claim 6, wherein the plurality of legs of the first container are configured to engage an inner surface of the second container when in the nested configuration.

8. The system of claim 7, wherein engagement of the plurality of legs of the first container with the inner surface of the second container limits contact between an outer surface of the first container and the inner surface of the second container when in the nested configuration.

9. The system of claim 8, wherein distal ends of the plurality of legs of the first container are configured to press outward against the inner surface of the second container above a conical lower portion of the second container.

10. A fermenter comprising:
a container defining an interior space for brewing a liquid; and
a valve assembly configured to be operatively coupled to a lower portion of the container for selective evacuation of the liquid from the interior space, the valve assembly including a valve and a racking arm, the valve including an aperture through which the liquid is selectively evacuated, the racking arm being configured to be removably received in the aperture.

11. The fermenter of claim 10, wherein the valve assembly is rotatable such that rotation of the valve outside of the interior space causes rotation of the racking arm inside the interior space.

12. The fermenter of claim 11, wherein the lower portion is a generally conical lower portion, the valve assembly extending through a substantially flattened portion of a curved sidewall of the conical lower portion when operatively coupled thereto.

13. The fermenter of claim 11, wherein the valve includes a valve member configured to selectively obstruct the aperture, the aperture being dimensioned to prevent the racking arm from contacting the valve member when the racking arm is received in the aperture.

14. The fermenter of claim 13, wherein a proximal end of the racking arm includes one or more O-rings configured to seal against an inner surface of the aperture when the racking arm is received in the aperture.

15. The fermenter of claim 14, wherein the proximal end includes one or more grooves in which the one or more O-rings are disposed.

16. The fermenter of claim 15, wherein the one or more grooves are formed by denting in a sidewall of the racking arm.

17. A racking arm assembly for a fermenter, the assembly comprising:
a valve including an aperture, the valve being configured to permit selective evacuation of liquid from an interior of the fermenter to a location outside of the fermenter through the aperture; and
a racking arm configured to be removably received in the aperture such that an outer surface of the racking arm exerts an outward pressure on an inner surface of the aperture when received therein.

18. The assembly of claim 17, wherein a size-differential between the racking arm and the aperture prevents the racking arm from contacting a member of the valve configured to selectively block the aperture.

19. The assembly of claim 17, wherein the outer surface of the racking arm includes an outer surface of an O-ring included in the racking arm.

20. The assembly of claim 19, wherein the O-ring is disposed in a dented recess formed in a sidewall of the racking arm.
